(19) United States
(12) Patent Application Publication
(10) Pub. No.: US 2023/0340377 A1
(43) Pub. Date: Oct. 26, 2023

(54) SOAP COMPOSITION

(71) Applicant: Firmenich SA, Satigny (CH)

(72) Inventors: Pabitra GHOSH, Singapore (SG); Jane TANG, Singapore (SG); Aparna VITTAL, Singapore (SG); Simon HURRY, Southal (GB); Arnaud STRUILLOU, Satigny (CH)

(73) Assignee: Firmenich SA, Satigny (CH)

(21) Appl. No.: 18/004,955

(22) PCT Filed: Jul. 14, 2021
(86) PCT No.: PCT/EP2021/069629

§ 371 Date: Jan. 10, 2023

(30) Foreign Application Priority Data
Jul. 22, 2020 (SG) 10202006987Y
Oct. 2, 2020 (EP) 20199851.5

(51) Int. Cl. C11D 9/44; C11D 17/00

(52) U.S. Cl. CPC C11D 9/442; C11D 17/0047

(57) ABSTRACT

The present invention relates to the field of perfumery, more particular it concerns soap compositions. The present invention relates to a soap composition comprising a soap active material and a perfume composition comprising perfume raw materials defined by LogP and used according specific proportions. The present invention also relates to a soap article comprising the soap composition and the use thereof as well as a method for modifying the olfactive character of the perfume composition under wet conditions on a skin, surface or in the air surrounding of the skin.

### TECHNICAL FIELD

The present invention relates to the field of perfumery, more particular it concerns soap compositions. The present invention relates to a soap composition comprising a soap active material and a perfume composition comprising perfume raw materials defined by LogP and used according specific proportions. The present invention also relates to a soap article comprising the soap composition and the use thereof as well as a method for modifying the olfactive character of the perfume composition under wet conditions on a skin, surface or in the air surrounding of the skin.

### BACKGROUND OF THE INVENTION

One of the problems faced by the perfumery industry lies in the relatively rapid loss of the olfactive benefit provided by odoriferous compounds due to their volatility. The perfume industry has a particular interest for compositions or additives which are capable of prolonging or enhancing the perfuming effect of a mixture of several fragrances at the same time over a certain period of time. It is particularly desirable to obtain long-lasting properties for standard perfumery raw materials which are too volatile or have a poor substantivity by themselves, or which are only deposited in a small amount onto the surface of the final application.

Furthermore, fragrances play an important role in the perception of products performance and thus they often determine the consumer's choice for a given product. In detergents, hard surface cleaners or personal- or body-care products, the fragrances are incorporated as a free oil and/or encapsulated in microcapsules in order to deliver a pleasant odor to the skin or to the fabrics.

Finally, the customer demand for new olfactive experience is driving the developement of new perfume compositions.

It would be interesting to have a soap composition providing a dual effect with a change of olfactive character over time while showing a boost of freshness upon application.

The present disclosure provides a solution with a soap composition comprising perfume raw materials defined by LogP and used according specific proportions.

### DESCRIPTION OF THE INVENTION

The present invention addresses these needs and provides a soap composition that can impart a variety of impressions on the user at different point of usage. Moreover, such soap composition provides different odour profile by releasing certain group of materials when subjected to wet conditions.

According to the first aspect, the present invention relates to a soap composition comprising
a soap active material and
a perfume composition comprising perfume raw materials;
characterized in that the perfume raw materials comprise:
   from 0.01% to 50% by weight of a first group A of perfume raw materials having a LogP≤2.5, and
   from 10% to 60% by weight of a second group B of perfume raw materials having a LogP≥4
wherein the sum of perfume raw materials of group A and perfume raw materials of group B is greater than 35% by weight based on the total weight of the perfume raw materials.
   It should be understood that the sum of the perfume raw materials is 100%.

In a second aspect, the present invention relates to soap article comprising a soap composition as defined above, wherein the soap article may be in the form of a liquid cleanser, personal care soap bar, laundry bar, preferably a soap-based or syndet-based laundry bar, shaving composition, personal cleansing composition, body care product, cosmetic, shampoo, preferably a shower gel, preferably a soap-based shower gel or syndet-based shower gel, more preferably a syndet-based soap bar, or most preferably a soap bar.

In a third aspect, the present invention relates to the use of the soap composition or the soap article to modify the olfactive character of the perfume composition under wet conditions on a skin, surface or in the air surrounding of the skin.

In a fourth aspect, the present invention relates to a method for modifying the olfactive character of the perfuming composition under wet conditions on a skin, surface or in the air surrounding of the skin wherein the method comprises the step of applying soap composition of the present invention or the soap article of the present invention to a skin, surface or air.

In a further aspect, the present invention relates to a method for modifying the olfactive character of a composition comprising the steps consisting of:
providing a soap composition or soap article as defined above; and
subjecting said composition to wet conditions.

### DETAILED DESCRIPTION OF THE INVENTION

The inventors have invented a soap composition and soap articles, which releases a fragrance in certain situations of usage of such a soap composition or article and this in turn impart a variety of impressions on the user during different point of usage.

The newly formulated fragrance rule of this invention can provide improved fragrance characteristics while using soap composition such as soap bar in wet stage for a delightful consumer experience by sudden change in fragrance character from soap composition.

The present invention provides a soap composition comprising a perfume composition including a first group of perfuming compounds formed of raw materials and a second group of perfuming compounds formed of raw materials respectively defined by their LogP values.

The Applicant shows that the olfactive character of the perfume composition as defined in the present invention changes under wet conditions.

Indeed, the use of a perfume composition comprising a specific combination of raw materials defined according to their physico-chemical properties enables to create distinct smells within a single fragrance when said composition is subjected to wet conditions.

In other words, two different fragrance directions can be perceived by a consumer from a single fragrance during the transition from neat stage (typically before use) to wet stage (typically in use stage).

Although the present invention will be described with respect to particular embodiments, this description is not to be construed in a limiting sense.

Before describing in detail exemplary embodiments of the present invention, definitions important for understanding the present invention are given.

In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%. In particular, these terms indicate the exact value.

As used in this specification and in the appended claims, the used “%” or “wt %” means “% by weight” unless otherwise indicated.

By “soap composition” is understood as a composition comprising a perfume composition as defined in the present invention and soap active materials. The soap composition may be liquid or dry. Soap compositions are comprised in personal cleansing compositions such as soap bars, shower gels, or shampoos. A soap composition is comprised in a syndet-based or soap-based article. In particular, such soap composition is comprised in soap-based shower gel or syndet-based shower gel. In particular, the soap composition is comprised in a syndet-based soap bar. In particular, the soap composition is comprised in a soap bar.

By “soap active material” is understood as a material comprising a detergent or a surfactant and/or a salt of a weak acid. Typically, a soap active material may be a salt of weak acid, which may be a fatty acid and strong base like sodium hydroxide. The term surfactant and detergent can be used interchangeably. The detergent may be a synthetic detergent.

In one embodiment, the pH of soap solution may be above 5. The pH of soap solution may be preferably about 5.5. The pH of soap solution may be preferably between about 5 to 11. The pH of soap solution may be preferably between about 5.5 to 9. In another embodiment, the pH of soap solution may be above 8.0. Preferably, the pH of soap solution may be above 9.0. More preferably, the pH of soap solution may be between 9.0 to 10.5.

The soap active material may contain 3-70 wt %, preferably 4-40 wt %, most preferably 5-20 wt % moisture related to the total of the soap active material. The soap active materials may be a salt of fatty acid, in particular sodium salt of fatty acid.

“Soap-based” means that the sodium salt of fatty acid may be present. In a soap composition, the sodium salt of fatty acid may be present in an amount of 40-92 wt %, or 60-87 wt % or 75-84 wt % of the soap composition. The term “syndet-based” means that the soap composition or the soap article contains at least one synthetic detergent. The synthetic detergent may be a synthetic surfactant. The synthetic detergent may be present in an amount of 30-98 wt %, or 30-94 wt %, or 40-92 wt %, or 60-87 wt % or 75-84 wt %, preferably 30-94 wt % of the syndet-based soap composition or syndet-based soap article, such as the syndet based-soap bar, syndet-based laundry bar or syndet-based shower gel.

Syndet-based compositions or articles may comprise one or more synthetic detergent of the group selected from alkyl oligoglycosides and/or alkenyl oligoglycosides and olefin sulfonates. Syndet-based compositions or articles may preferably comprise one or more synthetic detergent of the group selected from LAS (Linear alkyl benzene sulphonic acid), AOS (alpha olefin sulfonate), ammonium lauryl sulfate, sodium laureth sulfate, sodium lauryl sarcosinate, sodium myreth sulfate, sodium cocoyl isethionate (SCI), coco monoglyceride sulfate (CMGS), alkyl glyceryl ether sulfonate (AGES) or combination thereof.

Syndet-based soap compositions or articles may be pure syndet compositions or articles, i.e. compositions or articles, in particular bars, based on synthetic detergents only. Preferably, the soap and synthetic detergents may also be mixed with soap active material in a soap composition. Such a syndet-base soap composition or article is known as soap-syndet or syndet-based soap composition. The syndet-based soap compositions or articles may comprise a soap active material and at least one synthetic detergent. The soap active material is in particular a sodium salt of fatty acid.

The soap active material may be comprised in soap noodles. Soap noodles may comprise fatty acids derived either from vegetable oil or animal fats. Soap noodles may be produced from the saponification of neutral fats and oil, neutralization of fatty acid and saponification of methyl esters. Soap noodles may be used as the main ingredient in the production of soap bars and may be therefore used as soap base. This soap base may have a typical smell, which differs from nature of raw material used for manufacturing soap noodle. Common tallow soap base gives synthetic, waxy, creamy, fatty, and animalic note, whereas palm fatty acid-based soap base generates earthy, plastic, burnt and metallic note. This soap base note may aggravate on keeping the soap composition during storage, thereby reducing the fragrance impact. In particular, some bases develop rancid note in addition to normal base smell. Fragrance ingredients of a soap base have the additional problem of covering base odour in addition impart fragrance experience.

As used herein, the term “perfume raw materials”, refers to a compound or mixture of perfuming ingredients, which are used in a perfuming preparation or composition to impart a hedonic effect. In other words such perfuming ingredients, to be considered as being a perfuming one, must be recognized by a person skilled in the art as being able to impart or modify in a positive or pleasant way the odour of a composition, and not just as having an odour.

As used herein, the term “perfuming ingredient” it is meant a compound, which is used for the primary purpose of conferring or modulating an odour. In other words such an ingredient, to be considered as being a perfuming one, must be recognized by a person skilled in the art as being able to at least impart or modify in a positive or pleasant way the odour of a composition, and not just as having an odour. For the purpose of the present disclosure, perfume accord also includes combination of perfuming ingredients with substances which together improve, enhance or modify the delivery of the perfuming ingredients, such as perfume precursors, emulsions or dispersions, as well as combinations which impart an additional benefit beyond that of modifying or imparting an odour, such as long-lasting, blooming, malodour counteraction, antimicrobial effect, microbial stability, insect control.

The nature and type of the perfuming ingredients do not warrant a more detailed description here, which in any case would not be exhaustive, the skilled person being able to select them on the basis of its general knowledge and according to intended use or application and the desired organoleptic effect. In general terms, these perfuming ingredients belong to chemical classes as varied as alcohols, aldehydes, ketones, esters, ethers, acetates, nitriles, terpenoids, nitrogenous or sulphurous heterocyclic compounds and essential oils, and said perfuming co-ingredients can be of natural or synthetic origin. Many of these ingredients are in any case listed in reference texts such as the book by S. Arctander, Perfume and Flavor Chemicals, 1969, Montclair, New Jersey, USA, or its more recent versions, or in other works of a similar nature, as well as in the abundant patent literature in the field of perfumery. It is also understood that said ingredients may also be compounds known to release in a controlled manner various types of perfuming compounds.

According to the invention, the perfume composition can comprise in addition to perfume raw materials, at least one solvent to dissolve said perfume raw materials, which is of current use in the perfumery industry. The solvent is preferably chosen in the group consisting of dipropylene glycol (4-oxa-2,6-heptanediol+2-methyl-3-oxa-1,5-hexanediol+2,4-dimethyl-3-oxa-1,5-pentanediol), Isopar M (hydrocarbons C13-C14), Isopar L (hydrocarbons C11-C13), isopropyl myristate (isopropyl tetradecanoate) ethyle citrate (triethyl 2-hydroxy-1,2,3-propanetricarboxylate), triacetine (1,2,3-propanetriyl triacetate), benzyl benzoate, 1,3-propanediol, mixture of methyl dihydroabietate and methyl tetrahydroabietate, vegetable oils such as almond oil, argan oil, cotton oil, corn oil, olive oil, sunflower oil, castor oil and mixtures thereof.

In other words, it means that solvents are not included in the perfume raw materials as defined in the present invention.

The perfume composition can comprise in addition to perfume raw materials at least one compound known to release in a controlled manner various types of perfuming compounds also known as properfume or profragrance. Non-limiting examples of suitable properfume may include 4-(dodecylthio)-4-(2,6,6-trimethyl-2-cyclohexen-1-yl)-2-butanone, 4-(dodecylthio)-4-(2,6,6-trimethyl-1-cyclohexen-1-yl)-2-buta none, trans-3-(dodecylthio)-1-(2,6,6-trimethyl-3-cyclohexen-1-yl)-1-butanone, 2-phenylethyl oxo(phenyl)acetate, 3,7-dimethyl-2,6-octadien-1-yl hexadecanoate, (2-((2-methylundec-1-en-1-yl)oxy)ethyl)benzene, 1-methoxy-4-(3-methyl-4-phenethoxybut-3-en-1-yl)benzene, (3-methyl-4-phenethoxybut-3-en-1-yl)benzene, 1-(((Z)-hex-3-en-1-yl)oxy)-2-methylundec-1-ene, (2-((2-methylundec-1-en-1-yl)oxy)ethoxy)benzene, 2-methyl-1-(octan-3-yloxy)undec-1-ene, 1-methoxy-4-(1-phenethoxyprop-1-en-2-yl)benzene, 1-methyl-4-(1-phenethoxyprop-1-en-2-yl)benzene, 2-(1-phenethoxyprop-1-en-2-yl)naphthalene, (2-phenethoxyvinyl)benzene, 2-(1-((3,7-dimethyloct-6-en-1-yl)oxy)prop-1-en-2-yl)naphthalene or a mixture thereof.

According to the invention, the perfume raw materials comprise:
from 0.01% to 50%, preferably from 2 to 50%, more preferably from 5 to 50% by weight of a first group A of perfume raw materials having a LogP ≤2.5, and
from 10% to 60%, preferably from 15 to 55%, more preferably from 15 to 50%, even more preferably from 20 to 50% by weight of a second group B of perfume raw materials having a LogP ≥4
   wherein the sum of perfume raw materials of group A and perfume raw materials of group B is greater than 35% by weight based on the total weight of the perfume raw materials.

According to an embodiment, the sum of perfume raw materials of group A and perfume raw materials of group B is comprised between 35% and 90% by weight based on the total weight of the perfume raw materials.

The skilled person will be able to select the raw materials from the first group and raw materials of the second group according to their LogP value on the basis of his general knowledge. LogP is the common logarithm of estimated octanol-water partition coefficient, which is known as a measure of lipophilicity.

The LogP values of many perfuming compound have been reported, for example, in the Pomona92 database, available from Daylight Chemical Information Systems, Inc. (Daylight CIS), Irvine, Calif., which also contains citations to the original literature. LogP values are most conveniently calculated by the “CLOGP” program, also available from Daylight CIS. This program also lists experimental logP values when they are available in the Pomona92 database. The “calculated logP” (cLogP) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990). The fragment approach is based on the chemical structure of each perfume oil ingredient, and takes into account the numbers and types of atoms, the atom connectivity, and chemical bonding. The cLogP values, which are the most reliable and widely used estimates for this physicochemical property, are preferably used instead of the experimental LogP values in the selection of perfuming compounds which are useful in the present invention.

Thus, by adjusting a correct balance between raw materials having a low LogP and raw materials having a high LogP, a “2 in 1” fragrance is obtained where two different olfactive directions are provided under wet conditions in conjunction with an increase in intensity (boost).

According to an embodiment, the first group of perfuming raw materials is formed of perfume raw material having a LogP 2.5 and the second group of perfuming raw materials is made of perfume raw materials having a LogP 4.5.

According to another embodiment, the perfume raw materials comprise between 2-25% by weight of the first group A of perfume raw materials.

According to a particular embodiment, the sum of perfume raw materials of group A and perfume raw materials of group B having an odor detection threshold (ODT)≤2×10⁻³ μg/L is greater than 8%, preferably between 8 and 80%, more preferably between 15 and 80% based on the total weight of the perfume raw materials.

According to the invention, the term “Odour Detection Threshold” refers to the lowest vapour concentration of that material which can be olfactorily detected.

The odor threshold concentration of a perfuming compound is determined by using a gas chromatograph (“GC”). Specifically, the gas chromatograph is calibrated to determine the exact volume of the perfume oil ingredient injected by the syringe, the precise split ratio, and the hydrocarbon response using a hydrocarbon standard of known concentration and chain-length distribution. The air flow rate is accurately measured and, assuming the duration of a human inhalation to last 12 seconds, the sampled volume is calculated. Since the precise concentration at the detector at any point in time is known, the mass per volume inhaled is known and hence the concentration of the perfuming compound. To determine the threshold concentration, solutions are delivered to the sniff port at the back-calculated concentration. A panelist sniffs the GC effluent and identifies the retention time when odor is noticed. The average across all panelists determines the odor threshold concentration of the perfuming compound. The determination of odor threshold is described in more detail in C. Vuilleumier et al., Multidimensional Visualization of Physical and Perceptual Data Leading to a Creative Approach in Fragrance Development, Perfume & Flavorist, Vol. 33, September, 2008, pages 54-61.

According to a particular embodiment, the perfume composition further comprises at least 10% by weight of perfume raw materials of group C having a log P comprised between 2.5 and 4 (2.5 and 4 excluded) and/or an ODT with an odor detection threshold (ODT) of ≤2×10⁻³ μg/L.

As non-limiting examples of perfume raw materials with logP ≤2.5 and ODT≤2×10⁻³ ug/L air, one may cite compounds listed in table A below.

TABLE A
Perfume raw materials with logP ≤ 2.5 and ODT ≤ 2 × 10⁻³ ug/L
CHEMICAL NAME

2-(4-METHYL-1,3-THIAZOL-5-YL)-1-ETHANOL
3-ETHOXY-4-HYDROXYBENZALDEHYDE
2-ETHYL-3-HYDROXY-4(4H)-PYRANONE
4-(4-HYDROXYPHENYL)-2-BUTANONE
7-HYDROXY-2-CHROMENONE
PHENYL ETHYL ALCOHOL
ALDEHYDE ANISIQUE
CINNAMIC ALCOHOL
4-NONANOLIDE
2-METHOXY-4-(2-PROPEN-1-YL)PHENOL
METHYL 2,4-DIHYDROXY-3,6-DIMETHYLBENZOATE
PHENYL ETHYL ACETATE
VANILLIN
ISOEUGENOL
(3ARS,6SR,7ASR)-PERHYDRO-3,6-DIMETHYL-BENZO[B]FURAN-2-ONE
ETHYL BUTYRATE
METHYL NAPHTYL KETONE
7-METHYL-2H-1,5-BENZODIOXEPIN-3(4H)-ONE
BENZYL ACETONE
3-(1,3-BENZODIOXOL-5-YL)-2-METHYLPROPANAL
2,4-DIMETHYL-3-CYCLOHEXENE-1-CARBALDEHYDE
(+−)-3-PHENYLBUTANAL
BENZYLACETONE
4-(1,3-BENZODIOXOL-5-YL)-2-BUTANONE
(+−)-5-ETHYL-4-HYDROXY-2-METHYL-3(2H)-FURANONE (A) + (+−)-2-ETHYL-4-HYDROXY-
5-METHYL-3(2H)-FURANONE (B)
ETHYL ISOBUTYRATE
ETHYL METHYLPHENYLGLYCIDATE
ETHYL 2-METHYL-1,3-DIOXOLANE-2-ACETATE
1-PHENYLVINYL ACETATE

As non-limiting examples of perfume raw materials with logP ≥4 and ODT≤2×10⁻³ ug/L air, one may cite perfume raw materials of table B.

TABLE B
Perfume raw materials with logP ≥ 4 and ODT ≤ 2 × 10⁻³ ug/L air
CHEMICAL NAME

(4Z)-4-DODECENAL
3,3-DIMETHYL-5-(2,2,3-TRIMETHYL-3-CYCLOPENTEN-1-YL)-4-PENTEN-2-OL
{1-METHYL-2-[(1,2,2-TRIMETHYLBICYCLO[3.1.0]HEX-3-YL)METHYL]CYCLOPROPYL}METHANOL
2-METHYLUNDECANAL
(1S,1′R)-2-[1-(3′,3′-DIMETHYL-1′-CYCLOHEXYL)ETHOXY]-2-METHYLPROPYL PROPANOATE
(3AR,5AS,9AS,9BR)-3A,6,6,9A-TETRAMETHYLDODECAHYDRONAPHTHO[2,1-B]FURAN
1-(2,2,3,6-TETRAMETHYL-CYCLOHEXYL)-3-HEXANOL
1-(OCTAHYDRO-2,3,8,8-TETRAMETHYL-2-NAPHTALENYL)-1-ETHANONE
(2E)-TRIDEC-2-ENENITRILE
VERDYL PROPIONATE
NAPHTHO[2,1-B]FURAN, DODECAHYDRO3A,6,6,9A-TETRAMETHYL
PATCHOULOL
ALDEHYDE C12
1-[(1RS,6SR)-2,2,6-TRIMETHYLCYCLOHEXYL]-3-HEXANOL
(+)-(3R)-1-[(1R,6S)-2,2,6-TRIMETHYLCYCLOHEXYL]-3-HEXANOL
(3E,5Z)-1,3,5-UNDECATRIENE
PENTADECENOLIDE
(+−)-2-(4-METHYL-3-CYCLOHEXEN-1-YL)-2-PROPANETHIOL
ALDEYHYDE SUPRA
((−)-(2E)-2-ETHYL-4-[(1R)-2,2,3-TRIMETHYL-3-CYCLOPENTEN-1-YL]-2-BUTEN-1-OL
4-PENTEN-1-OL, 2-METHYL-4-(2,2,3-TRIMETHYL-3-CYCLOPENTEN-1-YL)-
IONONE, METHYL
3-MÉTHYL-CYCLOPENTADÉCANONE
1-(2,3,8,8-TETRAMETHYL-1,3,4,5,6,7-HEXAHYDRONAPHTHALEN-2-YL)ETHANONE
ALDEHYDE HEXYLCINNAMIQUE
(+−)-(1S,4AR,8S,8AR)-2,2,6,8-TETRAMETHYL-1,2,3,4,4A,5,8,8A-OCTAHYDRO-1-
NAPHTHALENOL
OXACYCLOHEXADECAN-2-ONE
MUSCENONE DELTA
DELTA DAMASCONE

As non-limiting examples of perfume raw materials having a log P comprised between 2.5 and 4 and an ODT with the odor detection threshold (ODT) of ≤2×10⁻³ μg/L, one may cite linalyl Acetate, benzyl benzoate, dihydromyrcenol, linalol, sclareolate ((−)-propyl (S)-2-(1,1-dimethylpropoxy)propanoate), ethyl acetoacetate, and mixtures thereof.

According to an embodiment, the perfume composition comprises at least one solvent to solubilized the perfume raw materials, said solvent is preferably chosen in the group consisting of dipropylene glycol, Isopar M (hydrocarbons C₁₃-C₁₄), Isopar L (hydrocarbons C₁₁-C₁₃), isopropyl myristate (isopropyl tetradecanoate) ethyle citrate (triethyl 2-hydroxy-1,2,3-propanetricarboxylate), triacetine (1,2,3-propanetriyl triacetate), benzyl benzoate, 1,3-propanediol, mixture of methyl dihydroabietate and methyl tetrahydroabietate, vegetable oils such as almond oil, argan oil, cotton oil, corn oil, olive oil, sunflower oil, castor oil and mixtures thereof.

When present, the solvent may be comprised up to 50%, preferably up to 30% by weight of the perfume composition.

The perfume composition of the invention can be used as a free oil and/or in an encapsulated form.

Indeed, the fragrance composition may be optionally encapsulated in a microcapsule or core-shell microcapsule, which refers to a delivery system comprising an oil-based core of a hydrophobic active ingredient encapsulated by a polymeric shell. The fragrance composition may be optionally entrapped (as a free oil and/or in an encapsulated form) within a matrix formed by the carrier material. The carrier material comprises a monomeric, oligomeric or polymeric carrier material, or mixtures of two or more of these. An oligomeric carrier may be a carbohydrate, the oligomeric carrier may be sucrose, lactose, raffinose, maltose, trehalose, fructo-oligosaccharides. Examples of a monomeric carrier materials are glucose, fructose, mannose, galactose, arabinose, fucose, sorbitol, mannitol, for example. Polymeric carriers have more than 10 monomeric units that are linked by covalent bonds. In a preferred embodiment, the carrier may be a polymeric carrier material. Non-limiting examples of polymeric carrier material includes polyvinyl acetates, polyvinyl alcohol, dextrines, maltodextrines, glucose syrups, natural or modified starch, polysaccharides, carbohydrates, chitosan, gum Arabic, polyethylene glycol, polyvinyl pyrrolidone, polyvinyl alcohol, acrylamides, acrylates, polyacrylic acid. The encapsulation of fragrances or perfumes into carrier materials may provide protection against aging, enhance impact during use and sustained-release from substrates. Microcapsules having a polymeric matrix can be obtained by spray-drying.

The nature of the polymeric shell of the microcapsule can vary.

According to a particular embodiment, the polymeric shell comprises a material selected from the group consisting of polyurea, polyurethane, polyamide, polyester, polyacrylate, polysiloxane, polycarbonate, polysulfonamide, polymers of urea and formaldehyde, melamine and formaldehyde, melamine and urea, or melamine and glyoxal and mixtures thereof.

According to a particular embodiment, the polymeric shell comprises a material chosen from the group consisting of polyurea and/or polyurethane.

The material encapsulating the hydrophobic material composition can be microcapsules which have been widely described in the prior art.

The nature of the polymeric shell from the microcapsules of the invention can vary. As non-limiting examples, the shell can be aminoplast-based, polyurethane-based, polyamide-based, polyester-based or polyurea-based.

According to an embodiment, the shell is a biopolymer-based shell comprising a protein.

The shell can also be hybrid, namely organic-inorganic such as a hybrid shell composed of at least two types of inorganic particles that are cross-linked, or yet a shell resulting from the hydrolysis and condensation reaction of a polyalkoxysilane macro-monomeric composition.

According to an embodiment, the shell comprises an aminoplast copolymer, such as melamine-formaldehyde or urea-formaldehyde or cross-linked melamine formaldehyde or melamine glyoxal.

According to another embodiment, the microcapsules have a polymeric shell resulting from complex coacervation wherein the shell is possibly cross-linked.

According to another aspect the shell is polyurea-based made from, for example but not limited to isocyanate-based monomers and amine-containing crosslinkers such as guanidine carbonate and/or guanazole. Certain polyurea microcapsules comprise a polyurea wall which is the reaction product of the polymerisation between at least one polyisocyanate comprising at least two isocyanate functional groups and at least one reactant selected from the group consisting of an amine (for example a water-soluble guanidine salt and guanidine); a colloidal stabilizer or emulsifier; and an encapsulated perfume. However, the use of an amine can be omitted.

According to a particular aspect, the colloidal stabilizer includes an aqueous solution of between 0.1% and 0.4% of polyvinyl alcohol, between 0.6% and 1% of a cationic copolymer of vinylpyrrolidone and of a quaternized vinylimidazol (all percentages being defined by weight relative to the total weight of the colloidal stabilizer). According to another aspect, the emulsifier is an anionic or amphiphilic biopolymer, which may be, in one aspect, chosen from the group consisting of gum Arabic, soy protein, gelatin, sodium caseinate and mixtures thereof.

The preparation of an aqueous dispersion/slurry of core-shell microcapsules is well known by a skilled person in the art. In one aspect, the microcapsule wall material may comprise any suitable resin and especially including melamine, glyoxal, polyurea, polyurethane, polyamide, polyester, etc. Suitable resins include the reaction product of an aldehyde and an amine, suitable aldehydes include, formaldehyde and glyoxal. Suitable amines include melamine, urea, benzoguanamine, glycoluril, and mixtures thereof. Suitable melamines include, methylol melamine, methylated methylol melamine, imino melamine and mixtures thereof. Suitable ureas include, dimethylol urea, methylated dimethylol urea, urea-resorcinol, and mixtures thereof. Suitable materials for making may be obtained from one or more of the following companies Solutia Inc. (St Louis, Missouri U.S.A.), Cytec Industries (West Paterson, New Jersey U.S.A.), Sigma-Aldrich (St. Louis, Missouri U.S.A.).

According to one aspect, the microcapsule is a one-shell aminoplast core-shell microcapsule obtainable by a process comprising the steps of:
1) admixing a perfume oil with at least a polyisocyanate having at least two isocyanate functional groups to form an oil phase;
2) dispersing or dissolving into water an aminoplast resin and optionally a stabilizer to form a water phase;
3) preparing an oil-in-water dispersion, wherein the mean droplet size is comprised between 1 and 100 microns, by admixing the oil phase and the water phase;
4) performing a curing step to form the wall of said microcapsule; and
5) optionally drying the final dispersion to obtain the dried core-shell microcapsule.

According to one aspect, the core-shell microcapsule is a formaldehyde-free capsule. A typical process for the preparation of aminoplast formaldehyde-free microcapsules slurry comprises the steps of
1) preparing an oligomeric composition comprising the reaction product of, or obtainable by reacting together:
   a. a polyamine component in the form of melamine or of a mixture of melamine and at least one C₁-C₄ compound comprising two NH2 functional groups;
   b. an aldehyde component in the form of a mixture of glyoxal, a C₄₋₆ 2,2-dialkoxy-ethanal and optionally a glyoxalate, said mixture having a molar ratio glyoxal/C₄₋₆ 2,2-dialkoxy-ethanal comprised between 1/1 and 10/1; and
   c. a protic acid catalyst;
2) preparing an oil-in-water dispersion, wherein the droplet size is comprised between 1 and 600 microns, and comprising:
   a. an oil;
   b. a water medium:
   c. at least an oligomeric composition as obtained in step 1;
   d. at least a cross-linker selected amongst:
      i. C₄-C₁₂ aromatic or aliphatic di- or tri-isocyanates and their biurets, triurets, trimmers, trimethylol propane-adduct and mixtures thereof; and/or
      ii. a di- or tri-oxiran compounds of formula:

A-(oxiran-2-ylmethyl)ₙ
wherein ₙ stands for 2 or 3 and 1 represents a C₂-C₆ group optionally comprising from 2 to 6 nitrogen and/or oxygen atoms;
e. optionally a C₁-C₄ compounds comprising two NH₂ functional groups;
3) Heating the dispersion; and
4) Cooling the dispersion.
   The above process is described in more details in International Patent Application Publication No. WO 2013/068255.
   According to another aspect, the shell of the microcapsule is polyurea- or polyurethane-based. Examples of processes for the preparation of polyurea and polyureathane-based microcapsule slurry are for instance described in International Patent Application Publication No. WO2007/004166, European Patent Application Publication No. EP 2300146, and European Patent Application Publication No. EP25799. Typically a process for the preparation of polyurea or polyurethane-based microcapsule slurry include the following steps:
a) Dissolving at least one polyisocyanate having at least two isocyanate groups in an oil to form an oil phase;
b) Preparing an aqueous solution of an emulsifier or colloidal stabilizer to form a water phase;
c) Adding the oil phase to the water phase to form an oil-in-water dispersion, wherein the mean droplet size is comprised between 1 and 500 μm, preferably between 5 and 50 μm; and
d) Applying conditions sufficient to induce interfacial polymerisation and form microcapsules in form of a slurry.

According to another particular embodiment, the soap composition further comprises a filler, wherein the filler is present in an amount of from 0.002 to 35 wt %, preferably 0.2 to 5.0 wt %, and is optionally one or more compound selected from the group comprising TiO₂, talc and sugar. The sugar used as filler may be any sugar, in particular sorbitol, or any sugar in combination with sorbitol. A soap article may comprise a filler.

In a second aspect, the present invention relates to soap article comprising a soap composition as defined above.

According to another particular embodiment, the soap article may be in the form of a liquid cleanser, personal care soap bar, laundry bar, preferably a soap-based or syndet-based laundry bar, shaving composition, personal cleansing composition, body care product, cosmetic, shampoo, preferably a shower gel, preferably a soap-based shower gel or syndet-based shower gel, more preferably a syndet-based soap bar, or most preferably a soap bar. In an embodiment, the soap article may be in the form of a laundry bar. In a further embodiment, the soap article may be in the form of a syndet-based soap bar, a soap bar or a soap-based shower gel or syndet-based shower gel. In a particular embodiment, the soap article may be in the form of a soap bar.

According to a particular embodiment, the soap composition and/or the soap article is not an antiperspirant or deodorant composition.

According to a particular embodiment, the soap composition and/or the soap article does not comprise an antiperspirant or deodorant active material.

According to a particular embodiment, the soap composition and/or the soap article is not a perfume composition. In other words, according to a particular embodiment, the soap composition and/or the soap article does not consist of a perfume composition.

In an embodiment, the soap bar or soap composition of the present invention may comprise one or more surfactants. The surfactant is one or more compound selected from the group consisting of sodium salt of fatty acid, such as sodium salt of palm oil fatty acid, sodium salt of palm kernel oil fatty acid, linear alkyl benzene sulphonic acid, ammonium lauryl sulfate, ammonium laureth sulfate, sodium lauryl sarcosinate and/or soudium myreth sulfate. A synthetic surfactant may be a synthetic surfactant of the group selected from LAS (Linear alkyl benzene sulphonic acid), AOS (alpha olefin sulfonate), ammonium lauryl sulfate, sodium laureth sulfate, sodium lauryl sarcosinate, sodium myreth sulfate, sodium cocoyl isethionate (SCI), coco monoglyceride sulfate (CMGS), alkyl glyceryl ether sulfonate (AGES) or combination thereof.

In a further embodiment the soap bar or soap composition of the present invention may optionally comprise one or more ingredients selected from a soap active material, surfactant, processing aid, humectant, filler, sequestrant, neutralizer, superfattening agent, binder and dye. In a particular embodiment the soap composition comprises at least a surfactant, a processing aid, a neutralizer, a humectant and a profragrance. In one embodiment, the processing aid may be sodium chloride, sodium sulphate, sodium carbonate or sodium phosphates or a combination thereof. In a particular embodiment, the processing aid may be sodium chloride. In a particular embodiment, the neutralizer may be sodium hydroxide. In a particular embodiment, the filler may be titanium dioxide, talcum powder, bentonite, starch, sodium sulphate (Na₂SO₄), sodium carbonate (Na₂CO₃), sodium phosphates or a combination thereof. The term “sodium phosphates” as used herein are sodium phosphates, which may exists in different grades. Moreover, the phosphates may be condensed anions including di-, tri-, tetra-, and polyphosphates. These salts may be in anhydrous water-free and hydrated forms. Sodium phosphate as used herein generally relates to sodium tripolyphosphate (Na₅P₃O₁₀). In a particular embodiment, the humectant may be glycerin, sorbitol, a sugar or a combination thereof. In a particular embodiment, the sequestrant may be tertrasodium etidronate, tertrasodium ethylenediaminetetraacetic acid (EDTA) or a combination thereof. In a particular embodiment, titanium dioxide is used as whitening agent. In a particular embodiment, the binder may be starch or a polymer. The polymer may be carboxymethyl cellulose. In another embodiment no binder is used in the soap composition. In a particular embodiment, the superfattening agent may be lauric acid. The superfattening agent may be present in an amount of 0.1 to 10 wt %, preferably of 1 to 5 wt % of the soap bar or of the soap composition. In a particular embodiment, the dye may be CI 12490, CI 12740, or CI 12150. The dye may be comprised in an amount of 0.000001 to 0.001 wt %, preferably of 0.00001 to 0.0001 wt % of the soap bar or of the soap composition.

According to another particular embodiment, the soap bar or the soap composition further comprises a filler, wherein the filler is present in an amount of from 0.002 to 35 wt %, preferably 0.2 to 5.0 wt %. The filler is optionally one or more compound selected from the group comprising TiO₂, talc, sugar, sodium sulphate, sodium carbonate or sodium phosphates. The sugar used as filler may be any sugar, in particular sorbitol, or any sugar in combination with sorbitol.

In a further embodiment, the soap bar of the present invention may have an air freshening effect. The soap bar of the invention has a long-lasting air freshening effect, when the soap bar is used normally in room such as a bathroom room. A normal use of soap bars might be more than 50 times per day for hand washing. A normal use of soap bars might be up to 50 times per day for hand washing. A normal use of soap bars might be about 20 times per day for hand washing. The air freshening effect of a soap bar might be at least for 12 hours. In particular, the air freshening effect of a soap bar might be at least for 18 hours. The air freshening effect of a soap bar might be up to for 3 months, when the soap bar is used normally. The air freshening effect of a dry soap bar might be at least for 3 months. The soap bar may have an air freshening effect in a wet state as well as in a dry state. A dry soap bar is a soap bar, which does not have contact to water. A dry soap bar might also be a soap bar, which had contact to water more than 2 hours, preferably more than 4 hours, more preferably more than 6 hours ago. The air freshening effect of a dry soap bar of the present invention might be over a prolonged period of time. The air freshening effect of a dry soap bar might be at least for 1 months, when the soap bar lies in the cabin. The air freshening effect of a dry soap bar might be up to 3 months, when the soap bar lies in the cabin. Therefore, even if the soap bar lies in a cabin or a toilet room, the air freshening effect is continuous.

The soap bar according to one embodiment of the invention may comprise any of the following ingredients either alone or in combination with each other in the respective amounts:
40-90 wt %, or preferably 60-85 wt % of sodium salt of fatty acid,
0.0-5.0 wt %, or preferably 0.0-3.0 wt % of linear alkyl benzene sulphonic acid,
optionally 0.0-5.0 wt %, or preferably 0.0-3.0 wt % of alpha olefin sulphonate,
optionally 0.0-5.0 wt %, or preferably 0.0-3.0 wt % of ammonium lauryl sulfate, ammonium laureth sulfate, sodium lauryl sarcosinate and/or sodium myreth sulfate,
0.05-1.5 wt %, or preferably 0.4-0.8 wt % of sodium chloride;
0.01-13 wt %, or preferably 0.01-2.0 wt % of sodium hydroxide,
0.1-35 wt %, or preferably 0.3-10 wt % or more preferably 0.2-5 wt % of a filler comprising talcum powder, bentonite, starch, sugar, sodium sulphate, sodium carbonate or sodium phosphate or a combination thereof;
0.1-9 wt %, or preferably 1.0-5.0 wt % of glycerin;
0.0-9.0 wt %, or preferably 0.0-5.0 wt % of sorbitol and/or a sugar;
0.1-0.5 wt %, or preferably 0.1-0.3 wt % of titanium dioxide;
0.001-0.4 wt %, or preferably 0.01-0.2 wt % of tetrasodium etidronate;
0.001-0.4 wt %, or preferably 0.01-0.2 wt % of tetrasodium EDTA;
0.1-3.0 wt %, or preferably 0.5-1.2 wt % of the perfume composition herein defined; and
8.0-18 wt %, or preferably 10-12 wt % of water by weight of the total soap bar.

In another aspect, the present invention relates to the use of the soap composition or the soap article to modify the olfactive character of the perfume composition under wet conditions on a skin, surface or in the air surrounding of the skin.

The term “surface” as used herein refers to any surface on which soap can be applied on. A surface may be a textile or a hard surface. A hard surface may be any of, but is not limited to, wood, ceramics, metal, glass, stone, plastic, or leather. A textile may be any of, but is not limited to, woven fabric or a non-woven fabric.

In a fourth aspect, the present invention relates to a method for modify the olfactive character of said composition under wet conditions on a skin, surface or in the air surrounding of the skin wherein the method comprises the step of applying soap composition of the present invention or the soap article of the present invention to a skin, surface or air.

In a further aspect, the present invention relates to a method for modifying the olfactive character of a composition comprising the steps consisting of:
providing a soap composition as defined above; and
subjecting said composition to wet conditions, typically water.

### EXAMPLES

The present invention will be described in further detail by way of the following non-limiting examples.

### Example 1: Soap Bar Formulation

A soap bar relates to the following composition in Table 1:

TABLE 1
Exemplary Soap Bar formulation

| Ingredients | Amount (% wt) |
|---|---|
| Sodium salt of Palm oil Fatty | 68.6 |
| acid | |
| Sodium salt of Palm Kernel oil | 17.15 |
| Fatty acid | |
| Sodium Chloride | 0.5 |
| Glycerine | 0.5 |
| Titanium Dioxide | 0.3 |
| Tetrasodium Etidronate | 0.15 |
| Tetrasodium EDTA (HEDP) | 0.1 |
| Perfume¹⁾ | 1 |
| Water | 11.7 (q.s.) |

¹⁾Fragrances A, B, C or X

### Example 2: Preparation of Soap Noodles

Soap noodle formulation (soap noodle of following composition is purchased from PT. Wilmar Nabati Indonesia under the brand name: WLFARIN SOAP NOODLE)

TABLE 2
Exemplary composition of soap noodles

| | | INCI | |
|---|---|---|---|
| Ingredients | Amount (% wt) | Nomenclature | CAS No. |
| Sodium Salt of | 68.6 | Sodium | 61790-79-2 |
| Palm Oil Fatty Acid | | Palmate | |
| Sodium Salt of | 17.15 | Sodium Palm | 61789-89-7 |
| palm Kemel fatty | | Kemelate | |
| Acid | | | |
| Glycerine | 0.5 | Glycerine | 56-81-5 |
| Water | 13 (q.s.) | Aqua | 7732-18-5 |
| Sodium Chloride | 0.5 | Sodium | 7647-14-5 |
| | | Chloride | |
| Tetrasodium | 0.15 | Sodium EDTA | 64-02-8 |
| Etidronate | | | |
| HEDP | 0.1 | Tetra Sodium | 3794-83-0 |
| | | Etidronate | |

| Ingredients | Amount (% wt) |
|---|---|
| Soap Noodle | 98.3 |
| Titanium Dioxide | 0.2 |
| (TiO2) | |
| Perfume¹⁾ | 1.5 |

¹⁾Fragrances A, B, C or X

Soap Noodles were mixed with TiO₂ and perfume by passing it several times in soap plodder. The soap noodles were then plodded in final plodder and stamped in the form of tablet in a stamper.

### Exemplary Preparation of Soap Noodles

Soap noodles were made from distilled palm and palm kernel fatty acid. The soap noodles had been supplied by PT. Wilmer Nabati Indonesia. The soap noodles were weighed out and added to a typical Z arm soap mixer. The soap noodles utilized in this example had a moisture content of about 12%. The soap materials utilized in the present invention have a moisture content between about 10% and about 15%. Titanium dioxide, fragrance added separately to the Z arm soap mixer. The components were mixed for about 5 to 10 minutes for homogenization and was then transferred from the mixer to a plodder. The plodder was a soap extruder composed of screw made of Aluminum/or stainless steel, a barrel that is jacketed for cooling by means of a water chiller, a hopper to feed the soap coming from Z arm mixer, a gearbox and electrical system to run the machine. The homogenized soap from Z arm mixer were processed through a plodder and stamped into soap bars in a soap bar making system. The soap bars were formed without any double stamping and with clean bar edges. The soap bars were packed in corrugated boxes. When used in a conventional manner, those soap bars were suitable for use on skin.

### Perfumery Compositions for Soap Bars—Overview

Fragrance A (table 3)
Fragrance B (table 4)
Fragrance C (table 5)
Comparative fragrance X (table 6)

TABLE 3
Composition of fragrance A

| Ingredients | % | cLog P | ODT |
|---|---|---|---|
| LINALYL ACETATE | 0.2 | 4.04 | >2.10⁻³ |
| HEXYLCINNAMIC ALDEHYDE | 23.5 | 4.86 | ≤2 × 10⁻³ |
| UNDECALACTONE GAMMA | 1.5 | 3.32 | ≤2 × 10⁻³ |
| 4-(4-METHOXYPHENYL)-2- | 0.6 | 0.93 | ≤2 × 10⁻³ |
| BUTANONE | | | |
| BUTYL HYDROXYPROPIONATE | 0.2 | <2.5 | >2.10⁻³ |
| ETHYL BUTYRATE | 0.3 | 2.03 | ≤2 × 10⁻³ |
| 4-(1,3-BENZODIOXOL-5-YL)-2- | 0.8 | 1.6 | ≤2 × 10⁻³ |
| BUTANONE | | | |
| (−)-(2E)-2-ETHYL-4-[(1R)-2,2,3- | 0.5 | 4.44 | ≤2 × 10⁻³ |
| TRIMETHYL-3-CYCLOPENTEN-1- | | | |
| YL]-2-BUTEN-1-OL | | | |
| 2-ETHYL-3-HYDROXY-4(4H)- | 1.5 | 0.76 | ≤2 × 10⁻³ |
| PYRANONE | | | |
| 3-ETHOXY-4- | 2.3 | 1.27 | ≤2 × 10⁻³ |
| HYDROXYBENZALDEHYDE | | | |
| PENTADECENOLIDE | 13.9 | 5.61 | ≤2 × 10⁻³ |
| (+−)-5-ETHYL-4-HYDROXY-2- | 0.2 | 0.75 | ≤2 × 10⁻³ |
| METHYL-3(2H)-FURANONE (A) + | | | |
| (+−)-2-ETHYL-4-HYDROXY-5- | | | |
| METHYL-3(2H)-FURANONE (B) | | | |
| 3-METHYLBUTYL 2- | 0.3 | 3.17 | >2.10⁻³ |
| METHYLPROPANOATE | | | |
| CINNAMYL ISOBUTYRATE | 0.1 | 3.76 | >2.10⁻³ |
| ETHYL ISOBUTYRATE | 0.4 | 2.03 | ≤2 × 10⁻³ |
| LINALOL | 14.4 | 2.94 | ≤2 × 10⁻³ |
| (+−)-2-(4-METHYL-3-CYCLOHEXEN- | 0.1 | 4.95 | ≤2 × 10⁻³ |
| 1-YL)-2-PROPANETHIOL | | | |
| 6,6-DIMETHOXY-2,5,5- | 2.5 | 3.9 | >2.10⁻³ |
| TRIMETHYL-2-HEXENE | | | |
| ETHYL METHYLPHENYLGLYCIDATE | 0.2 | 2.3 | ≤2 × 10⁻³ |
| METHYL 2-((1RS,2RS)-3-OXO-2- | 25.5 | 2.92 | ≤2 × 10⁻³ |
| PENTYLCYCLOPENTYL)ACETATE | | | |
| (+−)-(1S,4AR,8S,8AR)-2,2,6,8- | 0.3 | 5.24 | ≤2 × 10⁻³ |
| TETRAMETHYL-1,2,3,4,4A,5,8,8A- | | | |
| OCTAHYDRO-1-NAPHTHALENOL | | | |
| PATCHOULI OIL | 0.3 | 3.98 | ≤2 × 10⁻³ |
| VANILLIN | 0.4 | 0.72 | ≤2 × 10⁻³ |
| LIMONENE | 10.0 | 5.4 | >2.10⁻³ |

| | |
|---|---|
| % of raw materials having a LogP ≤ 2.5 | 6.7 |
| % of raw materials having a LogP ≥ 4 | 48.5 |
| % of raw materials having 2.5 < | 44.6 |
| LogP < 4 | |

TABLE 4
Composition of fragrance B

| Ingredients | % | cLog P | ODT |
|---|---|---|---|
| HEXYL ACETATE | 3.5 | 3.09 | >2.10⁻³ |
| (Z)-3-HEXENYL ACETATE | 1.2 | 2.62 | >2.10⁻³ |
| ALDEHYDE C8 | 2.1 | 2.94 | ≤2 × 10⁻³ |
| ALDEHYDE C10 | 15.0 | 3.99 | ≤2 × 10⁻³ |
| (+−)-2-METHYLUNDECANAL | 1.4 | 5.01 | ≤2 × 10⁻³ |
| UNDECALACTONE GAMMA | 9.3 | 3.32 | ≤2 × 10⁻³ |
| NAPHTHO[2,1-B]FURAN, DODECAHYDRO3A,6,6,9A- | 0.2 | 5.83 | ≤2 × 10⁻³ |
| TETRAMETHYL | | | |
| CITRONELLYL NITRILE | 19.5 | 3.03 | >2.10⁻³ |
| VERDYL PROPIONATE | 15.1 | 4.38 | ≤2 × 10⁻³ |
| (3E,5Z)-1,3,5-UNDECATRIENE | 0.2 | 5.68 | ≤2 × 10⁻³ |
| (+−)-3-(4-METHYL-3-CYCLOHEXEN-1-YL)BUTANAL | 1.7 | 3.51 | ≤2 × 10⁻³ |
| (+−)-2,6-DIMETHYL-5-HEPTENAL | 2.2 | 3.15 | ≤2 × 10⁻³ |
| (+−)-2-(4-METHYL-3-CYCLOHEXEN-1-YL)-2- | 0.1 | 4.95 | ≤2 × 10⁻³ |
| PROPANETHIOL | | | |
| METHYLNAPHTHYLKETONE | 2.0 | 2.5 | ≤2 × 10⁻³ |
| ETHYL 2 METHYLBUTYRATE | 2.5 | 2.58 | ≤2 × 10⁻³ |
| 1-(5,5-DIMETHYL-1-CYCLOHEXEN-1-YL)-4-PENTEN-1-ONE | 0.5 | 3.89 | ≤2 × 10⁻³ |
| PINENE MIXTURE | 1.7 | 5.43 | >2.10⁻³ |
| (4Z)-4-DODECENAL | 0.1 | 4.52 | ≤2 × 10⁻³ |
| (+−)-3-PHENYLBUTANAL | 0.7 | 2.34 | ≤2 × 10⁻³ |
| 2-TERT-BUTYL-1-CYCLOHEXYL ACETATE | 17.4 | 4.4 | >2.10⁻³ |
| 2-METHOXYNAPHTHALENE | 0.2 | 3.29 | ≤2 × 10⁻³ |
| 2,4-DIMETHYL-3-CYCLOHEXENE-1-CARBALDEHYDE | 3.4 | 2.34 | ≤2 × 10⁻³ |

| | |
|---|---|
| % of raw materials having a LogP ≤ 2.5 | 6.1 |
| % of raw materials having a LogP ≥ 4 | 36.2 |
| % of raw materials having 2.5 < LogP < 4 | 57.7 |

TABLE 5
Composition of fragrance C

| Ingredients | % | cLog P | ODT |
|---|---|---|---|
| BENZYL ACETATE | 7.0 | 2.04 | >2.10⁻³ |
| PHENYLETHYL ACETATE | 3.6 | 2.49 | >2.10⁻³ |
| PHENYLPROPYL ALCOHOL | 1.0 | 1.81 | >2.10⁻³ |
| 2-METHYL-4-PHENYL-2-BUTANOL | 2.5 | 2.69 | >2.10⁻³ |
| NAPHTHO[2,1-B]FURAN, | 2.0 | 5.83 | ≤2 × 10⁻³ |
| DODECAHYDRO3A,6,6,9A- | | | |
| TETRAMETHYL | | | |
| 7-HYDROXY-2-CHROMENONE | 0.6 | 1.35 | ≤2 × 10⁻³ |
| OXACYCLOHEXADECAN-2-ONE | 6.0 | 7.2 | ≤2 × 10⁻³ |
| DAMASCONE ALPHA | 0.8 | 3.65 | ≤2 × 10⁻³ |
| ETHYL DAMASCENATE | 1.2 | 3.16 | >2.10⁻³ |
| (+−)-(1- | 2.5 | 6.68 | >2.10⁻³ |
| ETHOXYETHOXY)CYCLODODECANE | | | |
| ETHYL 2-METHYL-1,3-DIOXOLANE- | 7.0 | 1.12 | ≤2 × 10⁻³ |
| 2-ACETATE | | | |
| GERANIOL PUR | 8.0 | 2.97 | ≤2 × 10⁻³ |
| 3-(1,3-BENZODIOXOL-5-YL)-2- | 1.0 | 1.28 | ≤2 × 10⁻³ |
| METHYLPROPANAL | | | |
| 3-(3,3-DIMETHYL-2,3-DIHYDRO- | 0.2 | 3.44 | ≤2 × 10⁻³ |
| 1H-INDEN-5-YL)PROPANAL (A) + 3- | | | |
| (1,1-DIMETHYL-2,3-DIHYDRO-1H- | | | |
| INDEN-4-YL)PROPANAL (B) + 3- | | | |
| (1,1-DIMETHYL-2,3-DIHYDRO-1H- | | | |
| INDEN-5-YL)PROPANAL (C) | | | |
| 1-(2,2,3,6-TETRAMETHYL- | 2.5 | 5.96 | ≤2 × 10⁻³ |
| CYCLOHEXYL)-3-HEXANOL | | | |
| METHYLISOEUGENOL | 2.0 | 2.85 | >2.10⁻³ |
| (+−)-(4E)-3-METHYL-4- | 0.8 | 5.98 | ≤2 × 10⁻³ |
| CYCLOPENTADECEN-1-ONE (A) + | | | |
| (+−)-(5E)-3-METHYL-5- | | | |
| CYCLOPENTADECEN-1-ONE (B) + | | | |
| (+−)-(5Z)-3-METHYL-5- | | | |
| CYCLOPENTADECEN-1-ONE (C) | | | |
| ETHYL 2 METHYLBUTYRATE | 0.8 | 2.58 | ≤2 × 10⁻³ |
| (+−)-TETRAHYDRO-2-ISOBUTYL-4- | 4.0 | 2.22 | >2.10⁻³ |
| METHYL-4(2H)-PYRANOL | | | |
| PHENYLETHYL ALCOHOL | 23.0 | 1.41 | ≤2 × 10⁻³ |
| (Z)-3-HEXEN-1-OL | 1.0 | 1.65 | >2.10⁻³ |
| (+−)-3,7-DIMETHYL-3-OCTANOL | 17.0 | 3.78 | >2.10⁻³ |
| 3-(DODECYLTHIO)-1-[(1RS,2SR)- | 1.8 | >8 | >2.10⁻³ |
| 2,6,6-TRIMETHYL-3-CYCLOHEXEN- | | | |
| 1-YL]-1-BUTANONE | | | |
| 3-(4,4-DIMETHYL-1-CYCLOHEXEN- | 0.8 | 3.3 | >2.10⁻³ |
| 1-YL)PROPANAL | | | |
| (3E)-4-(2,6,6-TRIMETHYL-1- | 2.5 | 3.88 | ≤2×10⁻³ |
| CYCLOHEXEN-1-YL)-3-BUTEN-2- | | | |
| ONE | | | |
| 2,4-DIMETHYL-3-CYCLOHEXENE-1- | 0.4 | 2.34 | ≤2 × 10⁻³ |
| CARBALDEHYDE | | | |

| | |
|---|---|
| % of raw materials having a LogP ≤ 2.5 | 48.6 |
| % of raw materials having a LogP ≥ 4 | 15.6 |
| % of raw materials having 2.5 < | 35.8 |
| LogP < 4 | |

TABLE 6
Comparative fragrance X formulation

| Raw materials | % | cLog P | ODT |
|---|---|---|---|
| BENZYL ALCOHOL | 0.09 | 0.53 | >2 × 10⁻³ |
| ETHYL 2-METHYL-1,3-DIOXOLANE-2- | 0.28 | 1.12 | >2 × 10⁻³ |
| ACETATE | | | |
| 2-PHENYLETHANOL | 1.69 | 1.41 | ≤2 × 10⁻³ |
| BENZYL ACETATE | 0.08 | 2.04 | >2 × 10⁻³ |
| (2,2-DIMETOXYETHYL)BENZENE | 0.11 | 2.1 | >2 × 10⁻³ |
| (+−)-TETRAHYDRO-2-ISOBUTYL-4- | 0.07 | 2.22 | >2 × 10⁻³ |
| METHYL-4(2H)-PYRANOL | | | |
| 3-METHYL-2-[(2Z)-PENT-2-EN-1- | 0.04 | 2.61 | ≤2 × 10⁻³ |
| YL]CYCLOPENT-2-EN-1-ONE | | | |
| 2-(4-METHYLCYCLOHEX-3-EN-1- | 0.24 | 2.91 | >2 × 10⁻³ |
| YL)PROPAN-2-OL | | | |
| (Z)-3,7-DIMETHYL-2,6-OCTADIEN-1-OL | 0.60 | 2.91 | >2 × 10⁻³ |
| METHYL 2-(3-OXO-2- | 1.89 | 2.92 | ≤2 × 10⁻³ |
| PENTYLCYCLOPENTYL)ETHANOATE | | | |
| (+−)-3,7-DIMETHYL-1,6-OCTADIEN-3-OL | 4.29 | 2.94 | ≤2 × 10⁻³ |
| (E)-3,7-DIMETHYL-2,6-OCTADIEN-1-OL | 0.99 | 2.97 | ≤2 × 10⁻³ |
| (+−)-2,6-DIMETHYL-7-OCTEN-2-OL | 5.06 | 3.21 | >2 × 10⁻³ |
| (+−)-3,7-DIMETHYL-6-OCTEN-1-OL | 6.16 | 3.37 | ≤2 × 10⁻³ |
| (Z)-3,7-DIMETHYL-1,6-NONADIEN-3-OL | 1.95 | 3.54 | ≤2 × 10⁻³ |
| (A) + (E)-3,7-DIMETHYL-1,6-NONADIEN- | | | |
| 3-OL (B) | | | |
| 6,7-DIHYDRO-1,1,2,3,3-PENTAMETHYL- | 0.43 | 3.65 | >2 × 10⁻³ |
| 4(5H)-INDANONE | | | |
| (+−)-3,7-DIMETHYL-3-OCTANOL | 0.17 | 3.78 | >2 × 10⁻³ |
| 3-(4-(TERT-BUTYL)PHENYL)-2- | 0.45 | 3.9 | ≤2 × 10⁻³ |
| METHYLPROPANAL | | | |
| UNDEC-10-ENAL | 0.14 | 3.93 | ≤2 × 10⁻³ |
| 3,7-DIMETHYLOCTA-1,6-DIEN-3- | 0.10 | 4.04 | >2 × 10⁻³ |
| YLACETATE | | | |
| 3,7-DIMETHYL-6-OCTENYL ACETATE | 0.51 | 4.22 | >2 × 10⁻³ |
| BENZYL 2-HYDROXYBENZOATE | 0.67 | 4.26 | ≤2 × 10⁻³ |
| 2-PHENYLETHYL 2- | 0.17 | 4.37 | >2 × 10⁻³ |
| HYDROXYBENZOATE | | | |
| CIS-4-(2-METHYL-2- | 12.19 | 4.47 | >2 × 10⁻³ |
| PROPANYL)CYCLOHEXYL ACETATE | | | |
| (A) + TRANS-4-(2-METHYL-2- | | | |
| PROPANYL)CYCLOHEXYL ACETATE | | | |
| (B) | | | |
| 2-(4-METHYLCYCLOHEX-3-EN-1- | 0.10 | 4.73 | >2 × 10⁻³ |
| YL)PROPAN-2-YL ACTETATE | | | |
| 1-(2,6,6-TRIMETHYL-1-CYCLOHEX-2- | 8.57 | 4.83 | ≤2 × 10⁻³ |
| ENYL) PENT-1-EN-3-ONE | | | |
| 2-BENZYLIDENEOCTANAL | 13.32 | 4.86 | >2 × 10⁻³ |
| DODECANAL | 0.22 | 4.94 | ≤2 × 10⁻³ |
| 2/3/4-(5,5,6- | 1.21 | 5.23 | ≤2 × 10⁻³ |
| TRIMETHYLBICYCLO[2.2.1]HEPT-2-YL)- | | | |
| 1-CYCLOHEXANOL (A/B/C) + 2-(1,7,7- | | | |
| TRIMETHYLBICYCLO[2.2.1]HEPT-2-YL)- | | | |
| 1-CYCLOHEXANOL (D) | | | |
| 1-((2RS,3RS)-2,3,8,8-TETRAMETHYL- | 6.29 | 5.24 | ≤2 × 10⁻³ |
| 1,2,3,4,5,6,7,8- | | | |
| OCTAHYDRONAPHTHALEN-2- | | | |
| YL)ETHANONE (A) + 1-[(2RS,3RS,8ARS)- | | | |
| 2,3,8,8-TETRAMETHYL-1,2,3,5,6,7,8,8A- | | | |
| OCTAHYDRO-2- | | | |
| NAPHTHALENYL]ETHANONE (B) + 1- | | | |
| [(2RS,3RS,8ARS)-2,3,8,8-TETRAMETHYL- | | | |
| 1,2,3,4,6,7,8,8A-OCTAHYDRO-2- | | | |
| NAPHTHALENYL]ETHANONE (C) | | | |
| HEXYL 2-HYDROXYBENZOATE | 0.63 | 5.55 | >2 × 10⁻³ |
| 1-DODECANOL | 0.36 | 5.65 | >2 × 10⁻³ |
| 3A,6,6,9A-TETRAMETHYL- | 0.14 | 5.83 | ≤2 × 10⁻³ |
| 2,4,5,5A,7,8,9,9B-OCTAHYDRO-1H- | | | |
| BENZO[E][1]BENZOFURAN | | | |
| 4,6,6,7,8,8-HEXAMETHYL-1,3,4,6,7,8- | 30.81 | 6.57 | <2 × 10⁻³ |
| HEXAHYDROCYCLOPENTA[G]- | | | |
| ISOCHROMENE | | | |

| | |
|---|---|
| % of raw materials having a LogP ≤ 2.5 | 2.58 |
| % of raw materials having a LogP ≥ 4 | 74.73 |
| % of raw materials having 2.5 < LogP < 4 | 22.69 |

### Example 2

Olfactive Evaluation of the Release of a Perfume Composition Incorporated into a Soap Bar Dry, Lathering Stage (Addition of Water) and Room Fill Assessment for Checking Perfume Profile Change in Dry, Wet and Room Fill Condition
a) All the soap bar samples were produced and matured for couple of days before evaluation.
b) Bar soap (neat dry) smell assessment: Neat dry bar are assessed from the Corrugated box; fragrance profiles are noted down. The common olfactive descriptors from all the evaluators are jotted down.
c) Bar soap (Lathering from forearm) smell assessment in evaluation booth (isolated small cabin with wash basin and air purging facility for cleaning up residual odour, if any): Soap is applied on clean forearm of one the volunteer. Bar soap (40 g weight)—see Table 1 is washed in running tap water for 10 seconds and the wet soap is rubbed 10 times in to and from motion in one forearm. With little water typical lather is generated on the applied area before evaluation. The process is repeated for other arm. Soap lathers on volunteers forearmare evaluated immediately by the evaluation panelists. The common olfactive descriptors from all the evaluators are jotted down.
d) The cabin bloom is assessed from outside through the smelling window immediately after the lathering.
e) The same cabin bloom is evaluated after 4 Hours.

TABLE 7
Olfactive performance results
Olfactive profile descriptor at different stages for the same fragrance

| | | | Cabin | Cabin | |
|---|---|---|---|---|---|
| | | | Bloom- | Bloom- | |
| Fragrance | | Lather | immediate | after 4 | |
| Reference | Neat Stage | Stage | (5 min) | hours | Overall Comments |
| X | Floral White | Floral | Floral | Flora | No change in olfactive |
| | Floral Rose | White | White | White | character across stages |
| | Transparent | Floral Rose | Floral Rose | Floral Rose | |
| | Florals Ald | Transparent | Transparent | Transparent | |
| | Musky | Florals Ald | Florals Ald | Florals Ald | |
| | | Musky | Musky | Musky | |
| A | Citrus | More red | More red | Fruity citrus | Change in dominant note |
| | grapefruit | fruity sweet | fruity sweet | grapefruit | observed from the neat |
| | green | | | | to lather stage-change |
| | | | | | is noticeable |
| B | Citrus lemon | More green | More green | Green | Change in dominant note |
| | fruity | herbaceous | herbaceous | herbaceous | observed from the neat |
| | | aldehydic | | citrus lime | to lather stage-change |
| | | | | | is noticeable |
| C | Woody amber | More floral | More floral | Floral rose | Change in dominant note |
| | | rose fruity | rose fruity | fruity | observed from the neat |
| | | | | amber | to lather stage-change |
| | | | | woody | is noticeable |

The evaluation showed significant change of hedonics in the lathering stage in presence of water for the soap bar comprising the perfume compositions according to the invention. The evaluation showed significant change of hedonics in the cabin bloom for the soap bar comprising the perfume compositions according to the invention.
Comparative fragrance X does not show any significant change.

1. A soap composition comprising
a soap active material, and
a perfume composition comprising perfume raw materials;
characterized in that the perfume raw materials comprise:
from 0.01% to 50% by weight of a first group A of perfume raw materials having a LogP ≤2.5, and
from 10% to 60% by weight of a second group B of perfume raw materials having a LogP ≥4
wherein the sum of perfume raw materials of group A and perfume raw materials of group B is greater than 35% by weight based on the total weight of the perfume raw materials.

2. The composition according to claim 1, wherein the first group of perfume raw materials comprises perfume raw material having a LogP ≤2.5 and the second group of perfuming raw materials comprises perfume raw materials having a LogP ≥4.5.

3. The composition according to claim 1, wherein the perfume raw materials comprise between 15-50% by weight of the second group B of perfume raw materials.

4. The composition according to claim 1, wherein the sum of perfume raw materials of group A and perfume raw materials of group B having an odor detection threshold (ODT)≤2×10⁻³ μg/L is greater than 8% by weight based on the total weight of the perfume raw materials.

5. The composition according to claim 1, wherein perfume raw materials from the first group A are selected from the group consisting of 2-(4-methyl-1,3-thiazol-5-yl)-1-ethanol, 3-ethoxy-4-hydroxybenzaldehyde, 2-ethyl-3-hydroxy-4(4H)-pyranone, 4-(4-hydroxyphenyl)-2-butanone, 7-hydroxy-2-chromenone, phenyl ethyl alcohol, aldehyde anisique, cinnamic alcohol, 4-nonanolide, 2-methoxy-4-(2-propen-1-yl)phenol, methyl 2,4-dihydroxy-3,6-dimethylbenzoate, phenyl ethyl acetate, vanillin, isoeugenol, (3aRS,6SR,7aSR)-perhydro-3,6-dimethyl-benzo[b]furan-2-one, ethyl butyrate, methyl naphtyl ketone, 7-methyl-2H-1,5-benzodioxepin-3(4H)-one, 3-(1,3-benzodioxol-5-yl)-2-methylpropanal, 2,4-dimethyl-3-cyclohexene-1-carbaldehyde, (+−)-3-phenylbutanal, benzylacetone, 4-(3,4-methylenedioxyphenyl)-2-butanone, 5-ethyl-4-hydroxy-2-methyl-furan-3-one, ethyl isobutyrate, ethyl methylphenylglycidate, ethyl 2-methyl-1,3-dioxolane-2-acetate, benzenemethanol, alpha-methylene, acetate, and mixtures thereof.

6. The composition according to claim 1, wherein perfume raw materials from the second group B are selected from the group consisting of (4Z)-4-dodecenal, 3,3-dimethyl-5-(2,2,3-trimethyl-3-cyclopenten-1-yl)-4-penten-2-ol, {1-methyl-2-[(1,2,2-trimethylbicyclo[3.1.0]hex-3-yl)methyl]cyclopropyl}methanol, 2-methylundecanal, (1S,1′R)-2-[1-(3′,3′-dimethyl-1′-cyclohexyl)ethoxy]-2-methylpropyl propanoate, (3aR,5aS,9aS,9bR)-3a,6,6,9a-tetramethyldodecahydronaphtho[2,1-b]furan, 1-(2,2,3,6-tetramethyl-cyclohexyl)-3-hexanol, 1-(octahydro-2,3,8,8-tetramethyl-2-naphtalenyl)-1-ethanone, (2e)-tridec-2-enenitrile, verdyl propionate, naphtho[2,1-b]furan, dodecahydro3a,6,6,9a-tetramethyl, patchoulol, aldehyde C12, 1-[(1RS,6SR)-2,2,6-trimethylcyclohexyl]-3-hexanol, (+)-(3R)-1-[(1R,6S)-2,2,6-trimethylcyclohexyl]-3-hexanol, (3E,5Z)-1,3,5-undecatriene, pentadecenolide, (+−)-2-(4-methyl-3-cyclohexen-1-yl)-2-propanethiol, aldeyhyde supra, ((−)-(2e)-2-ethyl-4-[(1R)-2,2,3-trimethyl-3-cyclopenten-1-yl]-2-buten-1-ol, 4-penten-1-ol, 2-methyl-4-(2,2,3-trimethyl-3-cyclopenten-1-yl), ionone, methyl, 3-methyl-cyclopentadécanone, aldehyde hexylcinnamique, (+−)-(1S,4aR,8S,8aR)-2,2,6,8-tetramethyl-1,2,3,4,4a,5,8,8a-octahydro-1-naphthalenol, oxacyclohexadecan-2-one, muscenone delta, delta damascone and mixtures thereof.

7. The soap composition according to claim 1, wherein the perfume composition is present in the amount of from 0.01 to 10 wt %, based on the total weight of the soap composition.

8. The soap composition according to claim 1, further comprising a filler.

9. The soap composition according to claim 8, wherein the filler is one or more compounds selected from the group consisting of TiO₂, talc, sodium sulphate, sodium carbonate, sodium phosphate and sugar.

10. A soap article comprising a soap composition according to claim 1.

11. The soap article according to claim 10, in the form of a liquid cleanser, soap bar, laundry bar, shaving composition, personal cleansing composition, body care product, cosmetic, shampoo, or a shower gel.

12. The soap article according to claim 11, in the form of a soap bar.

13. A method for modifying the olfactive character of the perfume composition under wet conditions on a skin, surface or in the air surrounding of the skin, the method comprising the step of applying the soap composition according to claim 1 to the skin, surface or air.

14. The soap composition according to claim 7, wherein the perfume composition is present in the amount of from 0.1 to 3 wt %, based on the total weight of the soap composition.

15. The soap composition according to claim 14, wherein the perfume composition is present in the amount of from 0.5 to 1.2 wt %, based on the total weight of the soap composition.

16. The soap composition according to claim 8, wherein the filler is present in an amount of from 0.002 to 35 wt %.

17. The soap composition according to claim 16, wherein the filler is present in an amount of from 0.2 to 5.0 wt %.

18. The soap article according to claim 11, in the form of a liquid cleanser, personal care soap bar, syndet-based soap bar, a soap-based or syndet-based laundry bar, shaving composition, personal cleansing composition, body care product, cosmetic, shampoo, or a soap-based shower gel or syndet-based shower gel.
